(19) United States
(12) Patent Application Publication
(10) Pub. No.: US 2008/0027705 A1
(43) Pub. Date: Jan. 31, 2008

(54) Speech translation device and method

(75) Inventor: Toshiyuki Koga, Kanagawa (JP)

Correspondence Address: NIXON & VANDERHYE, PC, 901 NORTH GLEBE ROAD, 11TH FLOOR, ARLINGTON, VA, 22203, US

(73) Assignee: Kabushiki Kaisha Toshiba, Tokyo (JP)

(21) Appl. No.: 11/727,161

(22) Filed: Mar. 23, 2007

(30) Foreign Application Priority Data
Jul. 26, 2006 (JP) 2006-203597

(51) Int. Cl. G06F 17/28; G06F 15/00; G10L 21/00

(52) U.S. Cl. 704/2; 704/231; 704/277; 704/E15.001

(57) ABSTRACT

A speech translation device includes a speech input unit, a speech recognition unit, a machine translation unit, a parameter setting unit, a speech synthesis unit, and a speech output unit, and a speech volume value of speech data to be outputted is determined from plural likelihoods obtained by the speech recognition/machine translation. With respect to a word with a low likelihood, the speech volume value is made small and is made hard to transmit to the user, and on the other hand, with respect to a word with a high likelihood, the speech volume value is made large and is especially emphasized and is transmitted to the user.

### CROSS-REFERENCE TO RELATED APPLICATIONS

This application is based upon and claims the benefit of priority from the prior Japanese Patent Application No. 2006-203597, filed on Jul. 26, 2006; the entire contents of which are incorporated herein by reference.

### TECHNICAL FIELD

The present invention relates to a speech translation device and method, which is relevant to a speech recognition technique, a machine translation technique and a speech synthesis technique.

### BACKGROUND OF THE INVENTION

In speech recognition methods, there is proposed a method in which among speech-recognized response messages, an uncertain portion in the speech recognition result is slowly repeated (see, for example, JP-A-2003-208196).

In this method, in the case where there is an inadequacy in the content of a speech sound spoken during a dialog with a person, the person can correct it by barging in at that place. At this time, a speech recognition device side intentionally slowly speaks a portion which is uncertain when the speech content has been created, and notifies the person that it is the doubtful portion, and it is possible to take much time for adding correction by barging in.

In the speech translation device, it is necessary to perform machine translation in addition to speech recognition. However, when data conversion is performed in the speech recognition and the machine translation, a failure in the conversion occurs to no small extent. The failure in this conversion has a higher possibility than that in only the speech recognition.

Thus, in the speech recognition, there are obtained an erroneous recognition and no recognition result, and in the machine translation, there are obtained a translation error and no translation result. The first rank conversion result in the order obtained according to likelihoods calculated in the speech recognition and the machine translation, including the failure in the conversion, is adopted, and is finally presented to the user by speech output. At this time, when a conversion result is at the first rank even if the value of its likelihood is low, the result is outputted even if it is a conversion error.

Then, in view of the problems, according to embodiments of the present invention, there is provided a speech translation device and method in which a translation result can be outputted by a speech sound so that the user can understand that there is a possibility of failure in speech recognition or machine translation.

### BRIEF SUMMARY OF THE INVENTION

According to embodiments of the present invention, a speech translation device includes a speech input unit configured to acquire speech data of an arbitrary language, a speech recognition unit configured to obtain recognition data by performing a recognition processing of the speech data of the arbitrary language and to obtain a likelihood of each of segments of the recognition data, a translation unit configured to translate the recognition data into translation data of another language other than the arbitrary language and to obtain a likelihood of each of segments of the translation data, a parameter setting unit configured to set a parameter necessary for performing speech synthesis from the translation data by using the likelihood of each of the segments of the recognition data and the likelihood of each of the segments of the translation data, a speech synthesis unit configured to convert the translation data into speech data for speaking in the another language by using the parameter of each of the segments, and a speech output unit configured to output a speech sound from the speech data of the another language.

According to the embodiments of the invention, the translation result can be outputted by the speech sound so that the user can understand that there is a possibility of failure in the speech recognition or machine translation.

### BRIEF DESCRIPTION OF THE DRAWINGS

FIG. 1 is a view showing the reflection of a speech translation processing result score to a speech sound according to an embodiment of the invention.

FIG. 2 is a flowchart of the whole processing of a speech translation device 10.

FIG. 3 is a flowchart of a speech recognition unit 12.

FIG. 4 is a flowchart of a machine translation unit 13.

FIG. 5 is a flowchart of a speech synthesis unit 15.

FIG. 6 is a view of similarity calculation between acquired speech data and phoneme database.

FIG. 7 is a view of HMM.

FIG. 8 is a path from a state S₀ to a state S₆.

FIG. 9 is a view for explaining translation of Japanese to English and English to Japanese using syntactic trees.

FIG. 10 is a view for explaining plural possibilities and likelihoods of a sentence structure in a morphological analysis.

FIG. 11 is a view for explaining plural possibilities in translation words.

FIG. 12 is a view showing the reflection of a speech translation processing result score to a speech sound with respect to “shopping”.

FIG. 13 is a view showing the reflection of a speech translation processing result score to a speech sound with respect to “went”.

FIG. 14 is a table in which relevant information of words before/after translation is obtained in the machine translation unit 13.

### DETAILED DESCRIPTION OF THE INVENTION

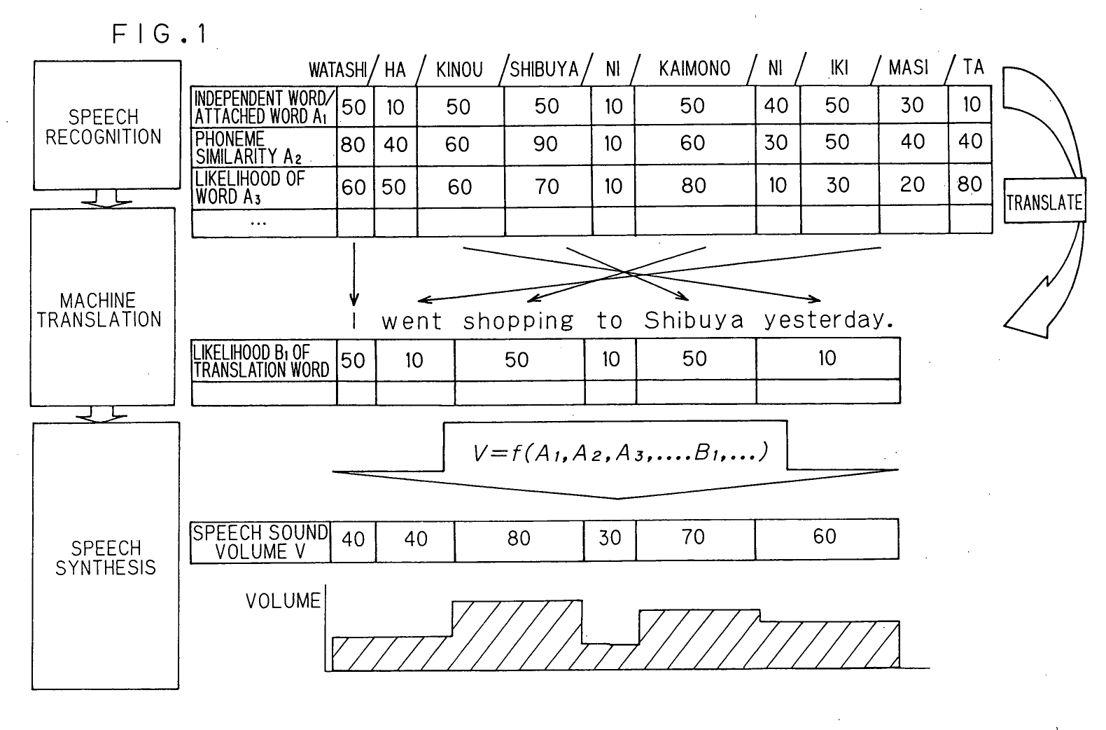

Hereinafter, a speech translation device 10 according to an embodiment of the invention will be described with reference to FIG. 1 to FIG. 14.

### (1) Outline of the Speech Translation Device 10

In the speech translation device 10 of the embodiment, attention is paid to a speech volume value at the time of speech output, and a speech volume value of speech data to be outputted is determined from plural likelihoods obtained by speech recognition/machine translation. By this processing, with respect to a word with a low likelihood, its speech volume value is made small so that the word becomes hard to transmit to the user, and with respect to a word with a high likelihood, its speech volume value is made large so that the word is especially emphatically transmitted to the user.

Based on the portion emphasized by the speech volume value (that is, information appearing to be certain as a processing result), the user can understand the intension of the transmission.

The likelihoods to which reference is made include, in speech recognition, a similarity by comparison of each phoneme, a score of a word by trellis calculation, and a score of a phrase/sentence calculated from a lattice structure, and in machine translation, a likelihood score of a translation word, a morphological analysis result, and a similarity score to examples. The values of the likelihoods in word units calculated by using these as shown in FIG. 1 are reflected on parameters at the time of speech generation, such as a speech volume value, a base frequency, a tone, an intonation, and a speed, and are used.

Irrespective of human hearing ability, there is a tendency that a word spoken at high volume is more clearly heard than a word spoken at low volume. When the difference of the volume is determined according to the likelihood of the speech translation processing, the user receiving the speech output data can more clearly hear the more certain word (word calculated to have a high likelihood). Besides, a person can obtain certain information to a certain degree even from fragmentary information. This is a human technique in which an analogy is made from the fragmentary information to infer information to be transmitted. By these two points, it is decreased that an erroneous word is presented and erroneous information is transmitted, and the user can obtain correct information.

Besides, as shown in FIG. 1, as a result of translation, “iki/mashi/ta” is translated into “went”, and since the range to influence a word to be speech outputted includes not only the word after the translation but also the word or phrase before the translation, and this is different from the calculation processing in the patent document 1. Besides, as compared with the patent document 1 which has an object to inform all results of speech recognition, this embodiment is different in that it is sufficient if the outline is transmitted even if all speech recognition result data are not transmitted.

### (2) Structure of the Speech Translation Device 10

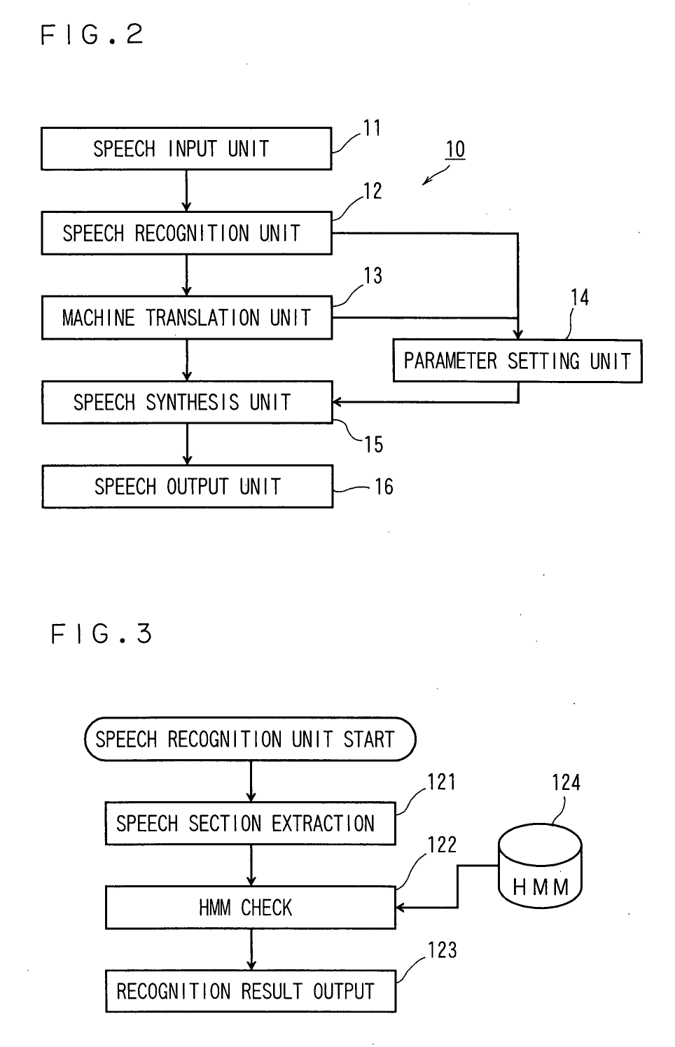

The structure of the speech translation device 10 is shown in FIG. 2 to FIG. 5.

FIG. 2 is a block diagram showing the structure of the speech translation device 10. The speech translation device 10 includes a speech input unit 11, a speech recognition unit 12, a machine translation unit 13, a parameter setting unit 14, a speech synthesis unit 15, and a speech output unit 16.

The respective functions of the respective units 12 to 15 can be realized also by programs stored in a computer.

### (2-1) Speech Input Unit 11

The speech input unit 11 is an acoustic sensor to acquire acoustic data of the outside, such as, for example, a microphone. The acoustic data here is a value at the time when a sound wave generated in the outside and including a speech sound, an environmental noise, or a mechanical sound is acquired as digital data. In general, it is obtained as a time series of sound pressure values at a set sampling frequency.

In the speech input unit 11, since a human speech sound is an object, acquired data is called “speech data”. Here, the speech data includes, in addition to data relating to a human speech sound as a recognition object in a speech recognition processing described later, an environmental noise (background noise) generated around the speaking person.

### (2-2) The Speech Recognition Unit 12

The processing of the speech recognition unit 12 will be described with reference to FIG. 3.

A section of a human speech sound contained in the speech data obtained in the speech input unit 11 is extracted (step 121).

A database 124 of HMM (Hidden Markov Model) created from phoneme data and its context is previously prepared, and the speech data is compared with the HMM of the database 124 to obtain a character string (step 122).

This calculated character string is outputted as a recognition result (step 123).

### (2-3) Machine Translation Unit 13

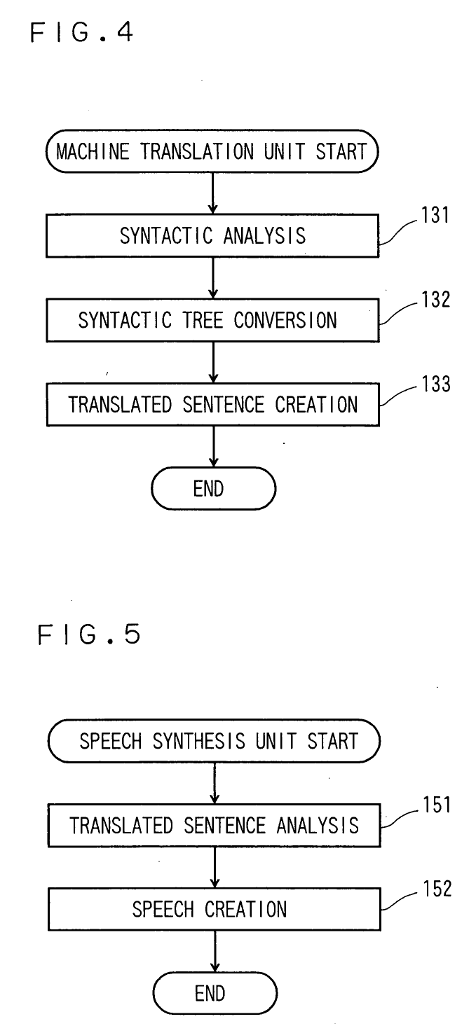

The processing of the machine translation unit 13 will be described with reference to FIG. 4.

The sentence structure of the character string of the recognition result obtained by the speech recognition unit 12 is analyzed (step 131).

The obtained syntactic tree is converted into a syntactic tree of a translation object (step 132).

A translation word is selected from the correspondence relation between the conversion origin and the conversion destination and creates a translated sentence (step 133).

### (2-4) Parameter Setting Unit 14

The parameter setting unit 14 acquires a value representing a likelihood of each word in the recognized sentence of the recognition processing result in the processing of the speech recognition unit 12.

Besides, a value representing a likelihood of each word in the translated sentence of the translation processing result is acquired in the processing of the machine translation unit 13.

From plural likelihoods for one word in the translated sentence obtained in this way, the likelihood of the word is calculated. The likelihood of this word is used to calculate the parameter used in the speech creation processing in the speech synthesis unit 15 and it is set.

The details of this parameter setting unit 14 will be described later.

### (2-5) Speech Synthesis Unit 15

The processing of the speech synthesis unit 15 will be described with reference to FIG. 5.

The speech synthesis unit 15 uses the speech creation parameter set in the parameter setting unit 14 and performs the speech synthesis processing.

As the procedure, the sentence structure of the translated sentence is analyzed (step 151), and the speech data is created based thereon (step 152).

### (2-6) Speech Output Unit 16

The speech output unit 16 is, for example, a speaker, and outputs a speech sound from the speech data created in the speech synthesis unit 15.

### (3) Content of Likelihood

In the parameter setting unit 14, a likelihood S_{Ri} (i=1, 2, . . . ) acquired, as its input, from the speech recognition unit 12 and a likelihood S_{Tj} (j=1, 2, . . . ) acquired from the machine translation unit 13 include values as described below. When they are finally reflected on the parameter of speech creation, since consideration is given to more emphasized presentation to the user, the likelihood is selected for the purpose that “more certain result is more emphasized”, and “important result is more emphasized”. For the former, a similarity or a probability value is selected, and for the latter, the quality/weighting of a word is selected.

### (3-1) Likelihood S_{R1}

The likelihood S_{R1} is the similarity calculated when the speech data and the phoneme data are compared with each other in the speech recognition unit 12.

When the recognition processing is performed in the speech recognition unit 12, the phoneme of the speech data acquired and extracted as a speech section is compared with the phoneme stored in the existing phoneme database 124, so that it is determined whether the phoneme of the compared speech data is “a” or “i”.

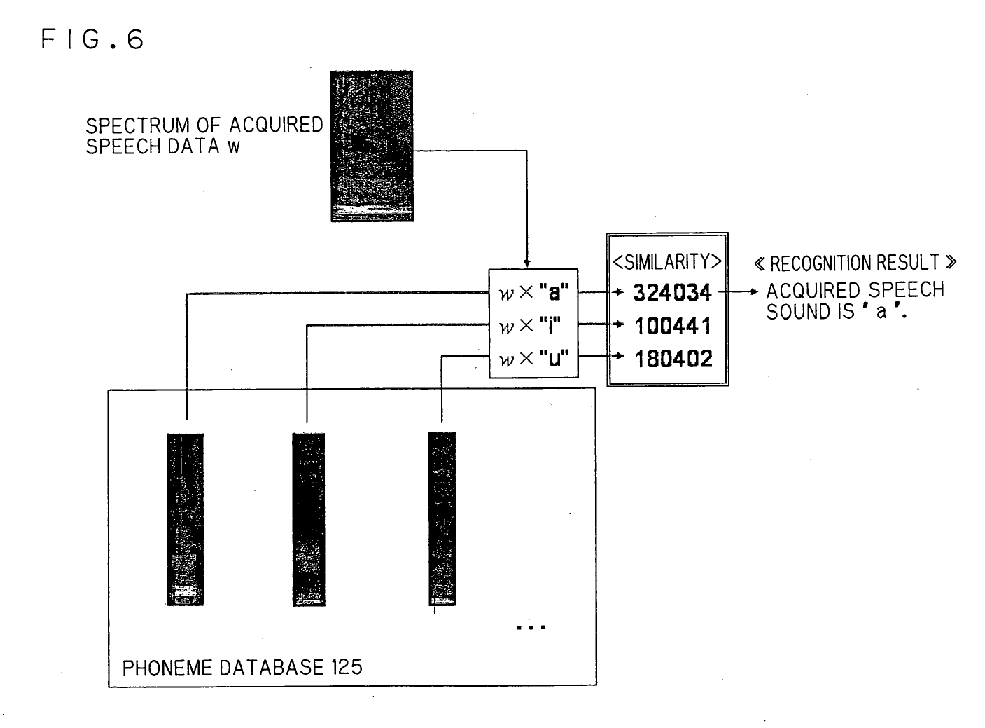

For example, in the case of “a”, with respect to the degree similar to “a” and the degree similar to “i”, since the degree similar to “a” is large, such judgment is made, and the “degree” is calculated as one parameter (FIG. 6). Although this “degree” is used as the likelihood S_{Ri} also in the actual speech recognition processing, after all, it is “the certainty that the phoneme is “a””.

### (3-2) Likelihood S_{R2}

The likelihood S_{R2} is an output probability value of a word or a sentence calculated by trellis calculation in the speech recognition unit 12.

In general, when the speech recognition processing is performed, in the inner processing to convert the speech data into a text, the probability calculation using the HMM (Hidden Markov Model) is performed.

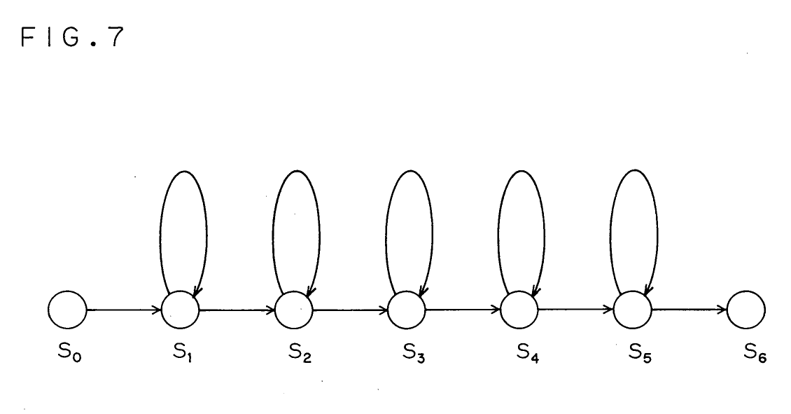

For example, in the case where “tokei” is recognized, the HMM becomes as shown in FIG. 7. As an initial state, a state stays at S₀. When a speech input occurs, a shift is made to S₁, and subsequently, a shift is made to S₂, S₃, . . . , and at the time of end of the speech, a shift is made to S₆.

In the respective states Sᵢ, the kind of an output signal of a phoneme and the probability of output of the signal are set, for example, at S₁, the probability of outputting /t/ is high. Learning is previously made by using a large amount of speech data and HMM is stored as a dictionary for each word.

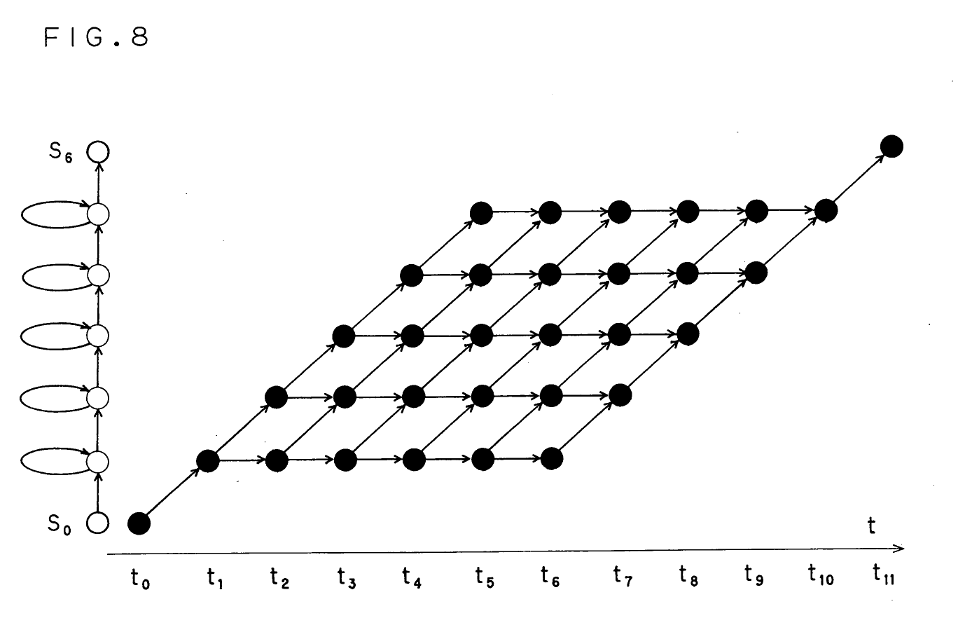

At this time, in a certain HMM (for example, the HMM shown in FIG. 7), in the case where the axis of the time series is also considered, as patterns of paths where a state transition can be taken, it is conceivable to trace paths (126 paths) as shown in FIG. 8.

The horizontal axis indicates the time, and the vertical axis indicates the state of the HMM. However, there is a series of signals outputted at each time ti (i=0, 1, . . . , 11), and the HMM is required to output this. The probability of outputting the signal series O for each of the 126 paths is calculated.

An algorithm in which the sum is taken for these probabilities to calculate the probability that the HMM outputs the signal series O is called a forward algorithm, while an algorithm of obtaining a path (maximum likelihood path) having the highest probability of outputting the signal series O among those paths is called a Viterbi algorithm. The latter is mainly used in view of calculation amount or the like, and this is also used for a sentence analysis (analysis of linkage between words).

In the Viterbi algorithm, when the maximum likelihood path is obtained, the likelihood of the maximum likelihood path is obtained by following expressions (1) and (2). This is a probability Pr(O) of outputting the signal series O in the maximum likelihood path, and is generally obtained in performing a recognition processing.

$$\begin{matrix}[ mathematical formula 1 ] & \\ α ( t , j ) = {max}_{k} \{ α ( t - 1 , k ) {a}_{kj} {b}_{j} ( {x}_{t} ) \} & ( 1 ) \\ Pr ( O ) = {max}_{k} \{ α ( T , k ) \} = \{ {x}_{j} \text{\textbar} j = {t}_{i} \} & ( 2 )\end{matrix}$$

Here, α(t, j) denotes the maximum probability in paths in which the signal series up to that time is outputted and a shift is made to a state at time t (t=0, 1, . . . , T). Besides, aₖⱼ denotes a probability that a transition occurs from a state Sₖ to a state Sⱼ, and bⱼ(x) denotes a probability that the signal x is outputted in the state Sⱼ.

As a result of this, the result of the speech recognition processing becomes a word/sentence indicated by the HMM which has produced the highest value among the output probability values of the maximum likelihood paths of the respective HMMs. That is, the output probability S_{R2} of the maximum likelihood path here is “the certainty that the input speech is the word/sentence”.

### (3-3) Likelihood S_{T1}

The likelihood S_{T1} is a morphological analysis result in the machine translation unit 13.

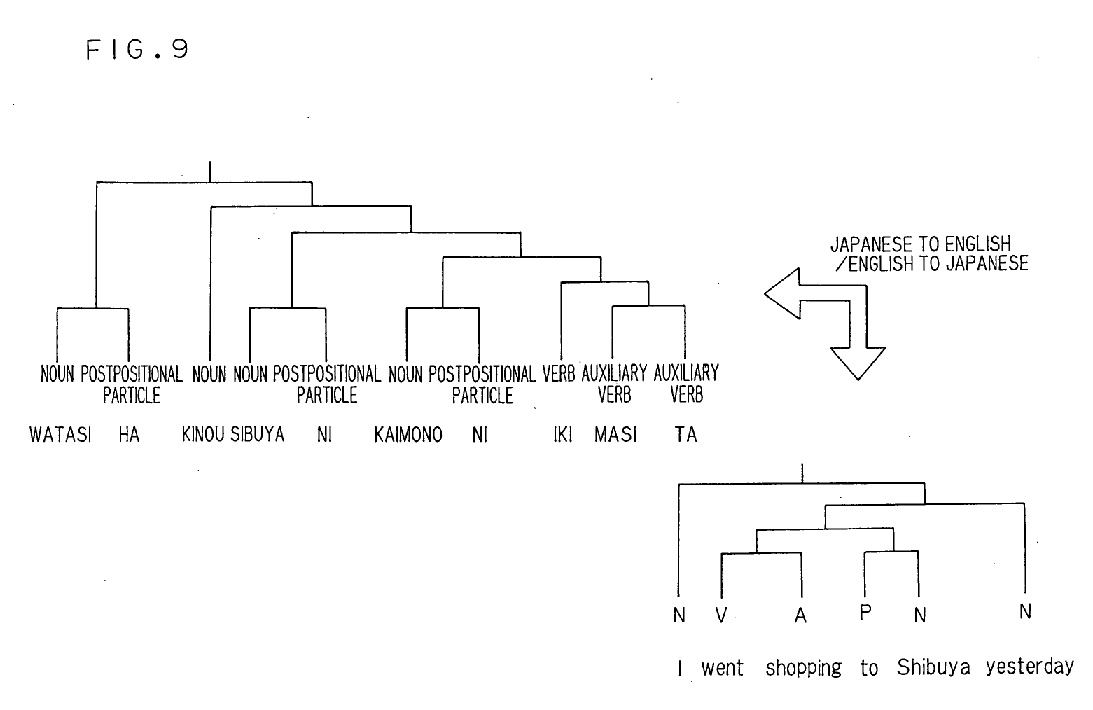

Every sentence is composed of minimum units each having a meaning, called a morpheme. That is, respective words of a sentence are classified into parts of speech to obtain the sentence structure. By using the result of the morphological analysis, the syntactic tree of the sentence is obtained in the machine translation, and this syntactic tree can be converted into the syntactic tree of the sentence of the paginal translation (FIG. 9). At this time, in the process of obtaining the syntactic tree from the sentence in the former, plural structures are conceivable. Those are produced from a difference in handling of postpositional particles, plural interpretations purely obtained by difference in segmentation, and so on.

For example, as shown in FIG. 10, in the speech recognition result of “ashitaha siranai”, there are conceivable patterns of “ashita hasiranai”, “ashita, hasira, nai”, and “ashitaha siranai”. Although “ashita, hasira, nai” is usually rarely used, there is a possibility that “ashita hasiranai” and “ashitaha siranai” are used according to circumstances at that time.

With respect to these, the certainty of the structure is conceivable based on the context of a certain word or whether it is in the vocabulary of the presently spoken field. Actually, in the processing, the most certain structure is determined by comparing such likelihood, and it is conceivable that the likelihood used at this time is used as the input. That is, it is a score to represent “certainty of the structure of a sentence”. At this time, among sentences, for example, only this word can be adopted with respect to a certain portion, while there are two combinations of morphemes with respect to a certain portion and both are meaningful, and as stated above, the likelihood varies according to every portion.

Then, not only the likelihood relating to the whole sentence, but also the likelihood of each word can be used as the input.

### (3-4) Likelihood S_{T2}

The likelihood S_{T2} is a weighting value corresponding to a part of speech classified by the morphological analysis in the machine translation unit 13.

Although the likelihood S_{T2} is different from another score in properties, the judgment of importance to be transmitted can be made by the result obtained by the morphological analysis.

That is, among parts of speech, with respect to an independent word, the meaning can be transmitted to a certain degree by only the word. However, with respect to an attached word, a specific meaning can not be represented by only the meaning of “ha” or “he”. In a situation where a meaning is transmitted to a person, there is a point that the independent word is to be transmitted more selectively than the attached word.

Even if information is fragmentary to a certain degree, a person can get a rough meaning, and there are many cases where it is sufficient if some independent words can be transmitted. From this, from the result of morphemes obtained here, that is, from the data of parts of speech of the respective morphemes, a value of importance relating to a meaning for each of parts of speech can be set. This value is made a score, and is reflected on the parameter of the final output speech sound.

The likelihood S_{T2} is performed also in the speech recognition unit 12 and the speech synthesis unit 15, and a morphological analysis specialized to each processing is performed, and the weight value is obtained also from the information of parts of speech and can be reflected on the parameter of the final output speech sound.

### (3-5) Likelihood S_{T3}

The likelihood S_{T3} denotes the certainty at the time when a translation word for a certain word is calculated in the machine translation unit 13.

It is the main function of the machine translation that at step 133, after the syntactic tree of a translated sentence is created, a check with the syntactic tree before the conversion is performed, and each word space in the translated sentence is filled with a translation word. At this time, although reference is made to a bilingual dictionary, there is a case where some translations exist also in the dictionary.

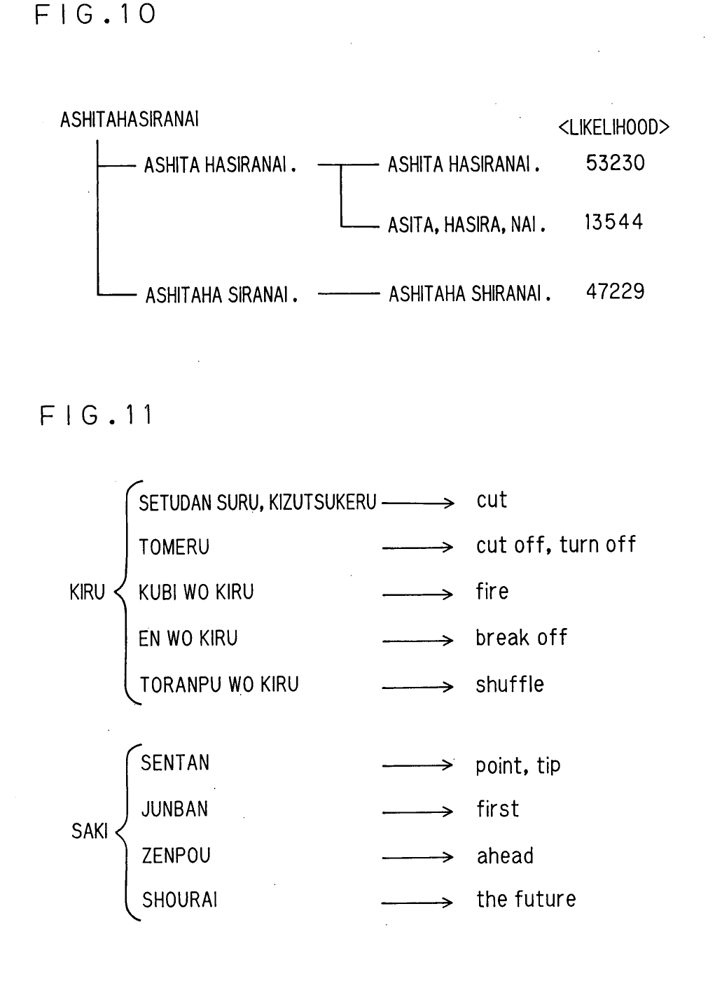

For example, in the case where Japanese to English translation is considered, as an English translation of “kiru”, various translations are conceivable such that in a scene where a material is cut by a knife, “cut” is used, in a scene where a switch is turned off, “turn off/cut off” is used, and in a scene where a job is lost, “fire” is used (FIG. 11).

Besides, also in the case of “kiru” in the meaning of “cut”, there is a case where another word is used according to the way of cutting (“thin”, “snipped with scissors”, “with saw”, etc.).

When an appropriate word is selected among these, as the standard of selection, there are many cases where it is obtained from empirical examples such that “this word is used in such a sentence”. In the case where although some words are equivalent to each other as translation words, they are delicately different in the meaning, a standard value used when a selection is made as to “which word is to be used in this case” is previously set.

Since the value used for such selection is the likelihood S_{T3} of the word, it can be mentioned here.

### (4) Calculation Method of the Parameter Setting Unit 14

Various likelihoods obtained from the speech recognition unit 12 and the machine translation unit 13 described above are used, and the degree of the emphasis for each morpheme of the sentence and the likelihood of the word are calculated. For that purpose, a weighted average or an integrated value are used.

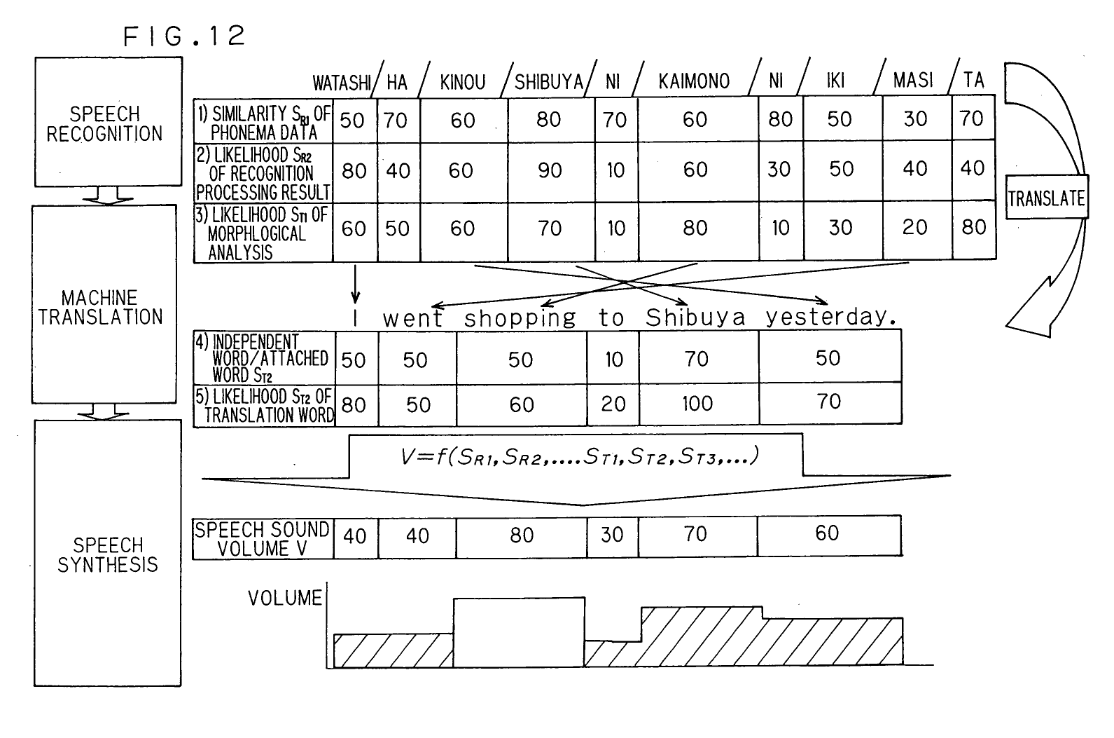

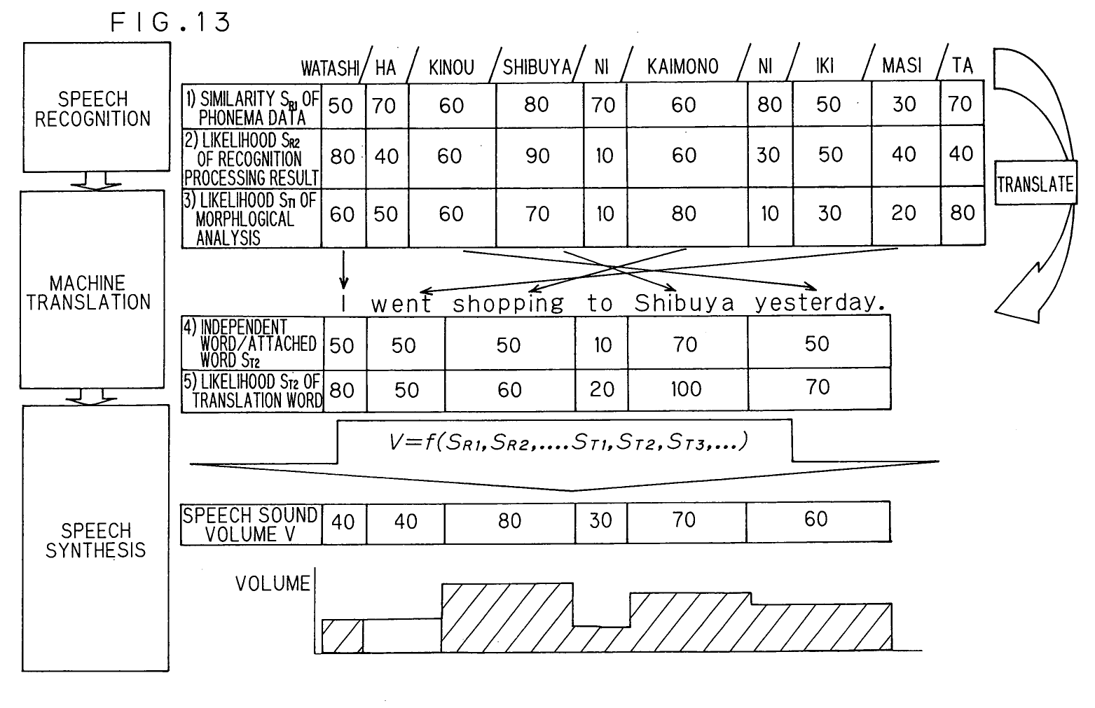

For example, in FIG. 12 and FIG. 13, consideration is given to a case where Japanese to English translation is performed such that “watashiha kinou sibuyani kaimononi ikimasita.” is translated into “I went shopping to Shibuya yesterday.”.

Various likelihoods obtained in the speech recognition unit 12 are made S_{R1}, S_{R2}, . . . , and various likelihoods obtained in the machine translation unit 13 are made S_{T1}, S_{T2}, . . . . At this time, in the case where an expression used for the likelihood calculation is made f( ), the obtained likelihood C is indicated by expression (3).

$$\begin{matrix}[ mathematical formula 2 ] & \\ C = f ( {S}_{R 1} , {S}_{R 2} , … {S}_{T 1} , {S}_{T 2} , … ) = \{ \begin{matrix}\sum {w}_{SRi} \cdot {S}_{Ri} + \sum {w}_{STj} \cdot {S}_{Tj} & ( weighted average ) \\ \prod {S}_{Ri} \cdot \prod {S}_{Tj} & ( integrated value )\end{matrix} & ( 3 )\end{matrix}$$

Here, with respect to S_{R1}, S_{R2}, . . . , S_{T1}, S_{T2}, . . . , a process is appropriately performed such that normalization is performed, or a value in the range of [0,1], such as a probability, is used as the likelihood value.

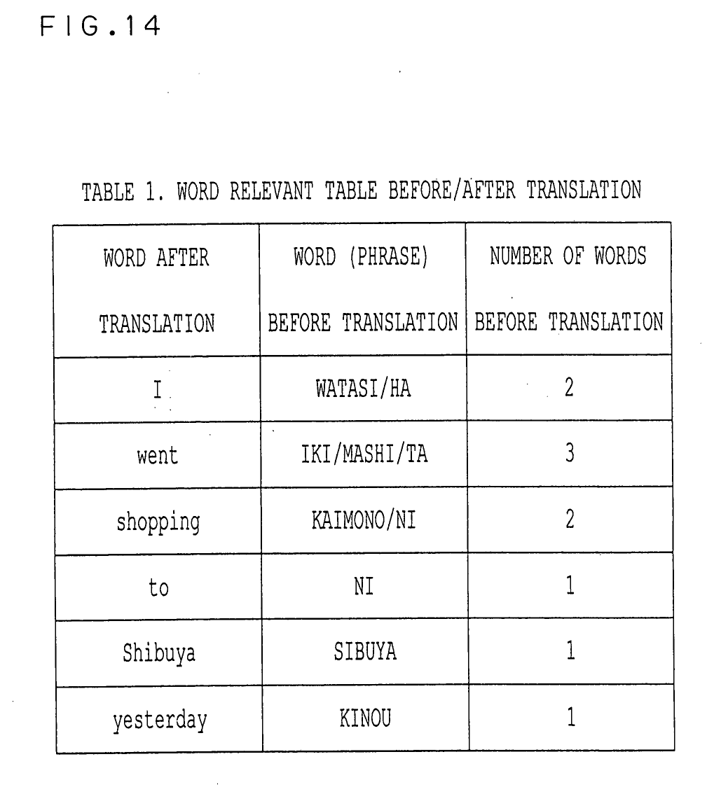

Besides, although the likelihood C is obtained for each word, relevant information of the word before and after the translation is obtained in the machine translation unit 13, and is recorded as a table. For example, it is shown in the table of FIG. 14. From this table, it is possible to indicate which word before the translation has an influence on a parameter for speech synthesis in each word after the translation. This table is used in the processing in FIG. 8.

For example, here, in the case where consideration is given to obtaining the likelihood C(“shopping”) with respect to “shopping” (FIG. 7), the translation word is traced and the likelihood relating to “kaimono” is extracted. Therefore, calculation is performed as follows:

C(“shopping”)=f(S_{R1}(“kaimono”),S_{R2}(kaimono”), . . . ,S_{T1}(“shopping”),S_{T2}(“shopping”), . . . ) (4)

Here, the likelihood S_{Ri}, S_{Tj} or C with a bracket denotes the likelihood for the word in the bracket.

Besides, when a translation word is traced in the case where consideration is given to obtaining the likelihood C (“went”) with respect to “went” (FIG. 8), the likelihood relating to “iki/mashi/ta” is extracted. In this case, “iki” means “go”, “ta” indicates the past tense, and “mashi” indicates a polite word. Thus, since “went” is influenced by these three morphemes, the calculation of the likelihood C(“went”) is performed as follows.

C(“went”)=f(S_{R1}(“iki”),S_{R1}(“mashi”),S_{R1}(“ta”),S_{R2}(“iki”),S_{R2}(“mashi”),S_{R2}(“ta”), . . . ,S_{T1}(“went”),S_{T2}(“went”) . . . ) (5)

By doing so, it is possible to cause all likelihoods before and after the translation to influence “went”.

Besides, at this time, reference is made to the table of FIG. 14, and since it can be said that the translation word is “went” from the meaning of “iki” and the past tense of “ta”, the influence on “went” is made large with respect to these. Besides, with respect to the polite word such as “mashi”, although it is structurally contained in “went”, since it is not particularly reflected, the influence is made small. Then, it is conceivable that the likelihood of “ikimashita” is calculated by weighting of the respective words, and this is used as the calculation of the likelihood C(“went”). That is, the calculation of following expressions (6) and (7) is performed.

S_{Ri}(“ikimashita”)=w(“iki”)S_{Ri}(“iki”)+w(“mashi”)S_{Ri}(“mashi”)+w(“ta”)S_{Ri}(“ta”) (6)

C(“went”)=f(S_{R1}(“ikimashita”),S_{R1}(“ikimashita”),S_{T1}(“went”),S_{T2}(“went”) . . . ) (7)

By doing so, w(“iki”) and w(“ta”) are set to be large, and w(“mashi”) is set to be small, so that it becomes possible to set the influence.

### (5) Parameter Setting in the Speech Synthesis Unit 15

In the parameter setting unit 14, the likelihoods of the respective words obtained by using various likelihoods obtained from the speech recognition unit 12 and the machine translation unit 13 are used, and a speech generation processing in the speech synthesis unit 15 is performed.

### (5-1) Kind of Parameter

Here, as parameters on which the likelihoods of the respective segments are reflected, there are a speech volume value, a pitch, a tone and the like. The parameter is adjusted such that a word with a high likelihood is expressed clearer by voice, and a word with a low likelihood is expressed vaguely by voice. The pitch indicates the height of a voice, and when the value is made large, the voice becomes high. The sound intensity/height pattern of sentence speech according to the speech volume value and the pitch becomes an accent in the sentence speech, and to adjust the two parameters can be said to be the control of the accent. However, with respect to the accent, the balance when the whole sentence is seen is also considered.

Besides, with respect to the tone (kind of voice), in the speech sound as a synthesized wave of sound waves of various frequencies, a difference occurs from a combination of frequencies (formants) detected intensely by resonance or the like. The formant is used as the feature of a speech sound in the speech recognition, and the pattern of the combination of these is controlled, so that various kinds of speech sounds can be created. This synthesis method is called formant synthesis, and is a speech synthesis method in which a clear speech sound is easily created. In a general speech synthesis device to create a speech sound from a speech database, a loss in speech sound occurs and the sound becomes unclear by processing in the case where words are linked, whereas according to this method, a clear speech sound can be created without causing such a loss in the speech sound. The clearness can be adjusted also by the control of this portion. That is, here, the tone and the quality of sound are controlled.

However, in this method, it is difficult to obtain a natural speech sound, and a robot-like speech sound is created.

Further, an unclear place may be slowly spoken by changing a speaking rate.

### (5-2) Adjustment of Speech Volume Value

When consideration is given to a case where a speech volume value is adjusted, as a speech volume value becomes large, information can be transmitted to the user clearly. On the contrary, as it becomes small, it becomes difficult for the user to hear the information. Thus, in the case where the likelihood C for each word is reflected on the speech volume value V, when the original speech volume value is made Vₒᵣᵢ, it is sufficient if

V=f(C, Vₒᵣᵢ) (8)

is a monotone increasing function with respect to C. For example, V is calculated by the product of C and Vₒᵣᵢ,

V=C·Vₒᵣᵢ (9)

In the case where consideration is given to a fact that unless C is large to a certain degree, the reliability is not assured, threshold processing is performed with respect to C to obtain

$$\begin{matrix}[ mathematical formula 3 ] & \\ V = \{ \begin{matrix}C \cdot {V}_{ori} & ( C \geq {C}_{th} ) \\ 0 & ( C < {C}_{th} )\end{matrix} & ( 10 )\end{matrix}$$

and in the case where the likelihood is low, the output itself is not performed. Besides, in the same way of thinking, it is also conceivable that the conversion function is set to be

V=Vₒᵣᵢ·exp(C) (11)

### By this, at a higher likelihood C, a large value V is outputted.

### (5-3) Adjustment of Pitch

Besides, in the case where consideration is given to the case of adjustment of the pitch, as the base frequency becomes high, the voice becomes high. Generally, the base frequency of a female voice is higher than that of a male voice. By making the base frequency high, the voice can be transmitted more clearly. Thus, in the case where the base frequency f₀ and the likelihood C of each word are made monotone increasing functions, this adjustment means becomes possible.

f₀=f(C,f_{0,ori}) (12)

By using the speech generation parameter obtained in this way, the speech synthesis at step 152 is performed in the speech synthesis unit 15. The outputted speech sound reflects the likelihood of each word, and as the likelihood becomes high, the word is more easily transmitted to the user.

However, when the speech creation is performed, there is conceivable a case where unnatural discontinuity occurs at a space between words, or a case where the likelihood is set to be low as a whole.

With respect to the former, measures are taken such that the words are continuously linked at the space, or the likelihood of a word with a low likelihood becomes slightly high in accordance with a word with a high likelihood.

With respect to the latter, it is conceivable to take measures such that the whole average value is raised and calculation is made, normalization is performed for the whole sentence, or when the likelihood is low as a whole, the sentence itself is rejected. Besides, it is necessary to perform an accent control in view of the whole sentence.

### (7) Modified Example

Incidentally, the invention is not limited to the embodiments, and various modifications can be made within the scope not departing from the gist.

For example, as the unit in which the likelihood is obtained, no limitation is made to the content of the embodiment, and it may be obtained for each segment.

Incidentally, “segment” is a phoneme or a combination of divided parts of the phoneme, and for example, a semi-phoneme, a phoneme (C, V), a diphone (CV, VC, VV), a triphone (CVC, VCV), and a syllable (CV, V) (V denote a vowel, and C denotes a consonant) are enumerated, and for example, these are mixed and the segment may have a variable length.

What is claimed is:

1. A speech translation device comprising:
a speech input unit configured to acquire speech data of an arbitrary language;
a speech recognition unit configured to obtain recognition data by performing a recognition processing of the speech data of the arbitrary language and to obtain a recognition likelihood of each of segments of the recognition data;
a translation unit configured to translate the recognition data into translation data of another language other than the arbitrary language and to obtain a translation likelihood of each of segments of the translation data;
a parameter setting unit configured to set a parameter necessary for performing speech synthesis from the translation data by using the recognition likelihood and the translation likelihood;
a speech synthesis unit configured to convert the translation data into speech data for speaking in the another language by using the parameter for each of the segments; and
a speech output unit configured to output a speech sound from the speech data of the another language.

2. The device according to claim 1, wherein the parameter setting unit sets the parameter by using one or plural likelihoods obtained for each segment of the arbitrary language in the speech recognition unit, and one or plural likelihoods obtained for each segment of the another language in the translation unit.

3. The device according to claim 1, wherein the parameter setting unit sets a speech volume value as the parameter.

4. The device according to claim 3, wherein the parameter setting unit increases the speech volume value as the likelihood becomes high.

5. The device according to claim 1, wherein the parameter setting unit sets one of a pitch, a tone, and a speaking rate as the parameter.

6. The device according to claim 1, wherein the likelihood obtained by the speech recognition unit is a similarity calculated when the speech data of the arbitrary language is compared with previously stored phoneme data, or an output probability value of a word or a sentence calculated by trellis calculation.

7. The device according to claim 1, wherein the likelihood obtained by the translation unit is a weight value corresponding to a part of speech classified by morphological analysis as a result of the morphological analysis in the translation unit, or certainty at a time when a translation word for a word is calculated.

8. The device according to claim 1, wherein the parameter setting unit sets the parameter by using a weighted average of the respective likelihoods or an integrated value of the respective likelihoods for the respective segments of the arbitrary language or the respective segments of the another language.

9. The device according to claim 1, wherein the segment is one of a sentence, a morpheme, a vocabulary and a word.

10. The device according to claim 1, wherein the translation unit stores a correspondence relation between a segment of the arbitrary language and a segment of the another language, and performs translation based on the correspondence relation.

11. A speech translation method comprising:
acquiring speech data of an arbitrary language;
obtaining recognition data by performing a recognition processing of the speech data of the arbitrary language and obtaining a recognition likelihood of each of segments of the recognition data;
translating the recognition data into translation data of another language other than the arbitrary language and obtaining a translation likelihood of each of segments of the translation data;
setting a parameter necessary for performing speech synthesis from the translation data by using the recognition likelihood and the translation likelihood;
converting the translation data into speech data for speaking in the another language by using the parameter for each of the segments; and
outputting a speech sound from the speech data of the another language.

12. A program product stored in a computer readable medium for speech translation, the program product comprising instructions of:
acquiring speech data of an arbitrary language;
obtaining recognition data by performing a recognition processing of the speech data of the arbitrary language and obtaining a recognition likelihood of each of segments of the recognition data;
translating the recognition data into translation data of another language other than the arbitrary language and obtaining a translation likelihood of each of segments of the translation data;
setting a parameter necessary for performing speech synthesis from the translation data by using the recognition likelihood and the translation likelihood o;
converting the translation data into speech data for speaking in the another language by using the parameter for each of the segments; and
outputting a speech sound from the speech data of the another language.
